(19) United States
(12) Patent Application Publication
(10) Pub. No.: US 2024/0111639 A1
(43) Pub. Date: Apr. 4, 2024

(54) RESTORING STATES OF REAL TIME CLOCK DEVICES FOR MULTIPLE HOSTS

(71) Applicant: HEWLETT PACKARD ENTERPRISE DEVELOPMENT LP, Spring, TX (US)

(72) Inventors: Christopher M. Wesneski, The Colony, TX (US); Theodore F. Emerson, Spring, TX (US)

(21) Appl. No.: 18/452,603

(22) Filed: Aug. 21, 2023

Related U.S. Application Data
(60) Provisional application No. 63/412,071, filed on Sep. 30, 2022.

(51) Int. Cl. G06F 11/14; G06F 1/14

(52) U.S. Cl. CPC G06F 11/1469; G06F 1/14

(57) ABSTRACT

A process includes, responsive to a primary power source being enabled, receiving, from a real time clock (RTC) device of a computer platform, an indication of a first time. Responsive to the primary power source being enabled, the process includes storing first data in a first non-volatile storage of the computer platform representing a snapshot of the first time and repeatedly updating the snapshot to cause the snapshot to track the first time. Responsive to the primary power source being disabled to begin a power outage, the process includes providing, by a timer of the computer platform powered by a secondary power source, a timer output that represents an accumulated time that corresponds to the power outage. The process includes restoring a state of the RTC device responsive to the primary power source being reenabled to end the power outage. The restoration includes, based on the accumulated time and the snapshot, determining a second time, and storing second data in the RTC device that represents the second time.

### BACKGROUND

A computer platform may have a real time clock (RTC) device for purposes of measuring time for the computer platform. An RTC device may provide data that represents a time-of-day (e.g., a time in terms of an hour, minute and second) and a calendar date (e.g., a date in terms of a year, month and day), which correspond to the rotational cycles of the Earth. An RTC device may perform other functions for a computer platform, such as providing alarm timers and providing storage for data (e.g., computer platform configuration data).

### BRIEF DESCRIPTION OF THE DRAWINGS

FIG. 1 is a block diagram of a computer platform having multiple hardware real time clock (RTC) devices for multiple hosts and an RTC device back-up system for the RTC devices according to an example implementation.

FIG. 2 is a block diagram of a system that is capable of supporting multiple hosts and which includes an RTC device back-up system to restore the states of RTC devices after a primary power outage according to an example implementation.

FIG. 3A is a flow diagram depicting a process to restore states of RTC devices responsive to primary power being restored according to an example implementation.

FIG. 3B is a flow diagram depicting a process to read RTC device snapshot data using multiple bus cycles according to an example implementation.

FIG. 4 is a flow diagram depicting a process to determine an updated time-of-day and an updated calendar date for an RTC device based on RTC device snapshot data and a time-on-battery (ToB) according to an example implementation.

FIG. 5 is a flow diagram depicting a process to maintain a snapshot of an RTC time responsive to a primary power source being enabled, measure an accumulated time corresponding to a primary power outage, and restore an RTC time of an RTC device responsive to the end of the power outage, according to an example implementation.

FIG. 6 is a block diagram of a computer platform having a management controller that includes multiple hardware RTC devices for multiple hosts of the computer platform according to an example implementation.

FIG. 7 is a block diagram of a computer platform that includes an update controller to maintain a snapshot of an RTC time responsive to a primary power source being enabled, a timer to measure an accumulated time corresponding to a primary power outage, and a restore controller to restore an RTC time of an RTC device responsive to the end of the primary power outage, according to an example implementation.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

A computer platform (e.g., a blade server) may provide multiple hosts (or “host instances”). In the context used herein, a “host” (or “host instance”) refers to a logical instance of a computing platform, and the logical instance includes an associated processor, memory and peripherals. In accordance with example implementations, the host (or “host instance”) may execute one or multiple operating system instances (e.g., Linux or Windows operating system instances), and the host instance may be associated with virtualization technology (e.g., a hypervisor). Each host may be provided by a corresponding set of resources of the computer platform, such as machine-readable instruction-based (or “software-based”) components and physical hardware components.

As an example of the allocation of resources of a computer platform to multiple hosts, a computer platform may have multiple, multicore central processing unit (CPU) semiconductor packages, or sockets, and the CPU processing cores of each socket may be assigned (e.g., exclusively assigned) to a respective host. As another example, the CPU processing cores of a particular socket may be assigned to multiple respective hosts. As another example, a computer platform may have multiple hardware RTC devices, and each RTC device may be assigned (e.g., exclusively assigned) to a different host.

An RTC device may be powered by (i.e., receive primary power from) a main, or primary, power source. As an example, a primary power source may include a power supply that receives an AC wall voltage and converts the AC wall voltage into one or multiple DC voltages that are provided to supply voltage rails of the computer platform. The primary power source may be part of the computer platform, or the primary power source may be separate from the computer platform. For example, the computer platform may be a blade server, and the primary power source may include a power distribution unit (PDU) for a rack in which the blade server is installed.

An RTC device may be coupled to an associated back-up, or secondary, stored energy source (e.g., a coin cell battery, a rechargeable battery or a supercapacitor) for purposes of providing back-up, or secondary, power to the RTC device during a primary power outage. As examples, a primary power outage may occur when a computer platform is controllably powered down, when the delivery of power from a primary power source is unexpectedly interrupted, when the computer platform is disconnected from a backplane connector, or because of another reason. In the context used herein, a primary power outage begins when a corresponding primary power source is disabled and ends when the primary power source is subsequently re-enabled. A “disabled” primary power source refers to power (called “primary power herein”) from the primary power source being unavailable, either due to the primary power source being directly shut down or disabled, as well as primary power being unavailable due to the primary power source being disconnected or the delivery of the primary power from the primary power source otherwise being interrupted. An “enabled” primary power source refers to the primary power from the primary power source being available.

The RTC device may have a volatile state, which may be corrupted or destroyed, if all power to the RTC device is removed. In this context, an RTC device's “state” generally refers to a set of data stored in the RTC device. The state may include, for example, data that is stored in one or multiple registers of the RTC device. For example, data stored in register(s) of the RTC device may represent a time (also called an “RTC device time” herein). In this context, a “time” (or “RTC device time”) may include one or more of the following: a time-of-day (e.g., an hour, a minute and a second), a day of the week, a month, a day of the month, a calendar year and/or a century. The data stored in register(s) of the RTC device may include non-time data. The state may include data that is stored in a volatile memory of the RTC device, such as data representing configuration data (e.g., basic input/output system (BIOS) configuration parameters) for the computer platform. Therefore, as examples, the data that is stored in an RTC device may include data representing a time-of-day, data representing a calendar date, data representing an alarm time, data representing a format for the time-of-day, data representing a configuration parameter for the RTC device, data representing a configuration of a computer platform, or other data. Providing secondary power to an RTC device allows the RTC device to retain its state, and the secondary power also allows the RTC device to update the state (e.g., maintain a current time-of-day and maintain a calendar date).

A computer platform that provides multiple hosts may correspondingly include multiple RTC devices (e.g., one RTC device for each host). One potential approach for providing secondary power for multiple RTC devices of a computer platform is for the computer platform to include a separate, dedicated secondary stored energy source for each RTC device. For example, a computer platform may include a “coin” cell battery to provide the secondary power for each RTC device. However, each additional stored energy source may contribute a significant incremental expense to the computer platform, taking into account such factors as the cost of each additional stored energy source, the cost of the electrical interface associated with each additional stored energy source and, the space footprint of the circuit board area associated with each additional stored energy source.

Another approach to providing secondary power for multiple RTC devices of a computer platform is to use a single secondary stored energy source, which is scaled up in size (relative to the size for a single RTC device) proportionately to the number of RTC devices. However, this approach may have the same costs associated with multiple secondary stored energy sources.

In accordance with example implementations that are described herein, a computer platform includes an RTC device state back-up system, which maintains back-up states using minimal resources for respective RTC devices in a space and cost-efficient way. In accordance with example implementations, the RTC device state back-up system allows the use of a single secondary stored energy source, which is sized for a single RTC device. Accordingly, among its possible advantages, the RTC device state back-up system may have a smaller space footprint and a lower associated cost, as compared to other multiple RTC device back-up solutions.

In general, when primary power is available, the RTC device state back-up system maintains and updates non-volatile snapshots (also called “state snapshots” herein) that represent the most recent states of an associated set of RTC devices. When a primary power outage occurs, in accordance with example implementations, the RTC device state back-up system measures a time (called a “time-on-battery,” or “ToB,” herein), which corresponds to the duration of the primary power outage. In accordance with example implementations, when primary power is subsequently restored, the RTC device state back-up system restores the updated states of the RTC devices based on the snapshots and the ToB.

The RTC device state back-up system, in accordance with example implementations, includes components that are in a primary power domain (i.e., components that receive primary power from a primary power source when available) and components that are in a secondary power domain (i.e., components that receive secondary power from a secondary power source). More specifically, in accordance with example implementations, the RTC device state back-up system includes non-volatile storage that stores data, which represents state snapshots for the RTC devices.

In this context, a “non-volatile storage” refers to a memory having a content that survives a loss of primary power. As an example, in accordance with some implementations, the RTC device state back-up system has a non-volatile storage that is formed from the combination of a volatile memory that receives the secondary power. As another example, in accordance with further implementations, the RTC device state back-up system may include a non-volatile storage formed from a truly non-volatile memory, such as a memory formed from flash memory devices, memristor memory devices, phase change memory devices, or other memory devices that store content when power is removed from the memory devices.

The RTC device state back-up system further includes a ToB timer (powered by the secondary power source) to measure the ToB corresponding to each primary power outage. An update controller (powered by the primary power source) of the RTC device state back-up system maintains and updates the state snapshots when primary power is available. A restore controller (powered by the primary power source) of the RTC device state back-up system, responsive to a primary power outage ending, restores the updated states of the RTC devices based on the snapshots and the ToB.

When the primary power source is available, the update controller, in accordance with example implementations, writes data to the non-volatile storage, which represents snapshots of time-of-day indications and calendar date indications, which are provided by the RTC devices. The update controller updates a given snapshot when the corresponding RTC device changes the corresponding value associated with the given snapshot, so that the snapshots track the time-of-day indications and calendar date indications, as long as primary power is available. Moreover, in accordance with example implementations, the update controller writes data to the non-volatile storage, which represents snapshots of RTC state components other than time-of-day and calendar date (e.g., register states and host configuration data), and when primary power is available, the update controller updates these snapshots to track the corresponding state components.

The ToB, in accordance with example implementations, is an accumulation of time, that begins when a particular primary power outage begins. In this manner, in accordance with example implementations, the ToB timer, in response to being triggered at Time A (when the primary power outage begins), counts upwardly from a reset value (e.g., a count of “0”) to provide a count (to provide a corresponding measure of an “accumulated time”) that increases with time. Therefore, at a given Time B, the output of the ToB time represents the time that has elapsed since Time A.

In accordance with example implementations, the ToB timer is triggered and therefore, begins counting, in response to the primary power source being disabled (which begins a primary power outage), and the ToB timer counts to provide an accumulated time until the ToB timer is reset in response to the completion of the restore controller (to prepare the RTC device state back-up system to once again track the snapshots). In accordance with some implementations, the counting by the ToB timer may be triggered in response to a power good signal transitioning from a first state representing stable primary power to a second state that represents that the primary power is unstable or is otherwise not available.

The restore controller, in accordance with example implementations, restores the RTC device states in response to a primary power source being re-enabled (and the corresponding primary power outage ending). In this manner, in accordance with example implementations, for state components that are not time-based, the restore controller reads data corresponding to the snapshots from the non-volatile storage of the RTC device state back-up system and writes the data to a memory in the primary power domain for purposes of restoring these state components. For state components (e.g., time-of-day and calendar date components) that are time-based, the restore controller reads and latches an accumulated time from the ToB timer; reads and latches data corresponding to the snapshots from the non-volatile storage; and adjusts the snapshots (e.g., adjusts the times-of-day and calendar dates represented by the snapshots) based on the accumulated time to derive adjusted times-of-day and calendar dates. Data representing the adjusted times-of-day and calendar dates may then be written to the RTC devices. Moreover, in accordance with example implementations, after the RTC devices are restored, the restore controller resets the ToB timer and enables the update controller to maintain the snapshots while primary power is available.

In accordance with some implementations, the RTC devices may be part of a management controller (e.g., a baseboard management controller (BMC)) of the computer platform. Among the particular advantages, the inclusion of the RTC devices on a management controller provides a relatively inexpensive and flexible approach to providing RTC devices for multiple hosts on the same computer platform, and the inclusion of the RTC devices on the management controller provides a separate RTC for the management controller's integrated management subsystem.

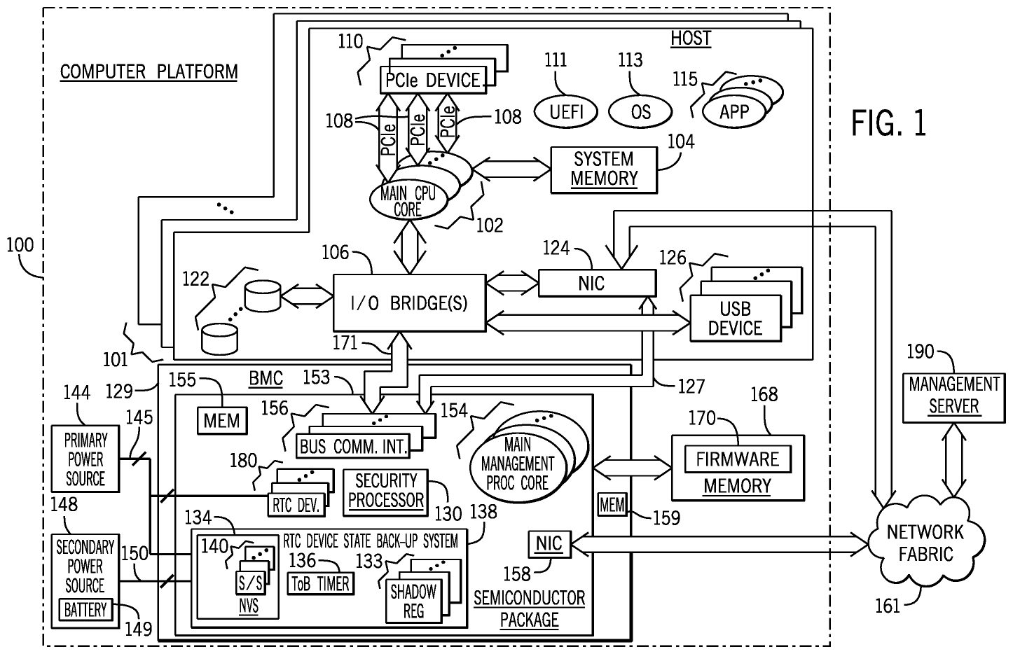

FIG. 1 depicts a computer platform 100 in accordance with example implementations. Referring to FIG. 1, the computer platform 100, in accordance with example implementations, is a modular unit, which includes a frame, or chassis. Moreover, this modular unit may include hardware that is mounted to the chassis and is capable of executing machine-readable instructions. A blade server is an example of the computer platform 100, in accordance with some implementations.

The computer platform 100 may have any of a number of different other forms, in accordance with further implementations. As examples, the computer platform 100 may be a server other than a blade server, such as a rack-mounted server or a standalone server. As other examples, the computer platform 100 may be a client, a thin client, a desktop computer, a tablet computer, a portable computer or a wearable computer. As other examples, the computer platform 100 may be a networking device, such as a network switch or a gateway. As another example, the computer platform 100 may be a storage device, such as a storage array. As other examples, the computer platform 100 may be a portable electronic device, a portable computer, a tablet computer, a thin client or a laptop computer. As other examples, the computer platform 100 may be a television, a modular switch, a consumer electronics device, an appliance, an edge processing system, a sensor system, a watch, a removable peripheral card, or, in general, any other processor-based device.

In accordance with example implementations, the computer platform 100 may be connected to a network fabric 161. The network fabric 161 may be associated with one or multiple types of communication networks, such as (as examples) Fibre Channel networks, Compute Express Link (CXL) fabric, dedicated management networks, local area networks (LANs), wide area networks (WANs), global networks (e.g., the Internet), wireless networks, or any combination thereof.

The computer platform 100 may include multiple hardware RTC devices 180 that are individually associated with respective hosts 101 of the computer platform 100 (e.g., each RTC device 180 may be associated with a different host 101). In this context, a “hardware” RTC device refers to an actual, or physical, component (e.g., a component containing logic gates, a plurality of registers and a memory), which provides one or multiple functions, or services, related to measuring a time that corresponds to the rotational cycles of the Earth. As an example of such a service, an RTC device 180 may provide data representing one or multiple values (e.g., one or multiple register values) that collectively represent a time-of-day (also called a “time” herein) in terms of a number of seconds, a number of minutes and a particular hour. As another example, an RTC device 180 may provide data representing one or multiple values (e.g., one or multiple register values) that collectively represent a calendar date (also called a “date” herein) in terms of a day of the week, a day of the month, a month and a year (e.g., a two digit representation for the year that omits the century or a four digit representation that includes the century). As another example, an RTC device 180 may provide one or multiple alarm timers that are triggered by programmed alarm times that correspond to particular times-of-day set points. An RTC device 180 may further provide one or multiple functions, or services, which are not related to measuring a time that corresponds to the rotational cycles of the Earth. For example, in accordance with some implementations, an RTC device 180 may have a volatile memory that stores data (e.g., configuration data) for the computer platform 100.

In accordance with example implementations, each RTC device 180 may be viewed as providing an “RTC instance.” In this context, an “RTC instance” refers to a logical or physical instance that is associated with measuring time (e.g., measuring at least one of a time of day, a day of the week, a day of the month, a year or a century). In an example, an RTC instance may be a logical instance that corresponds to a host 101, and the RTC instance may measure time for the host 101. In another example, an RTC instance may be a physical instance that measures time for a particular non-abstracted (or “physical”), hardware component of the computer platform 100, such as a baseboard management controller (BMC) 129.

In accordance with example implementations, the RTC devices 180 may be fabricated on one or multiple semiconductor die that are contained within one or multiple semiconductor packages (or “chips”). The semiconductor package may be any of a number of different semiconductor packages, such as a surface mount package, a through-hole package, a ball-grid array package, a small outline package, a chip-scale package, or any other container containing one or multiple semiconductor die.

For the example implementation that is depicted in FIG. 1, the RTC devices 180 are part of a semiconductor package 153. In this manner, the RTC devices 180 may be fabricated on one or multiple die of the semiconductor package 153, depending on the particular implementation. Moreover, as further depicted in FIG. 1, in accordance with example implementations, the semiconductor package 153 may be part of a management controller of the computer platform 100, such as the BMC 129.

In the context used herein, a “BMC,” or “baseboard management controller,” is a specialized service processor that monitors the physical state of a server or other hardware using sensors and communicates with a management system through a management network. The baseboard management controller may also communicate with applications running on one or multiple host instances through an input/output controller (IOCTL) interface driver, a representational state transfer (REST) application program interface (API), or some other system software proxy that facilitates communication between the baseboard management controller and applications. The baseboard management controller may have hardware level access to hardware devices that are located in a server chassis including system memory. The baseboard management controller may be able to directly modify the hardware devices. The baseboard management controller may operate independently of the operating system of the system in which the baseboard management controller is disposed. A baseboard management controller may be located on the motherboard or main circuit board of the server or other device to be monitored.

The fact that a baseboard management controller is mounted on a motherboard of the managed server/hardware or otherwise connected or attached to the managed server/hardware does not prevent the baseboard management controller from being considered “separate” from the server/hardware. As used herein, a baseboard management controller has management capabilities for sub-systems of a computing device, and is separate from a processing resource that executes an operating system of a computing device. The baseboard management controller is separate from a processor, such as a central processing unit, which executes a high-level operating system or hypervisor on a system.

In accordance with further implementations, the RTC devices 180 may not be part of a management controller or part of a BMC. For example, in accordance with further implementations, the RTC devices 180 may be individual, standalone semiconductor packages. In accordance with further implementations, the RTC devices 180 may be part of an I/O bridge 106 or other hardware component of the computer platform 100.

In accordance with example implementations, components of the computer platform 100 receive power (called “primary power” herein) from a primary power source 144. As an example, the primary power source 144 may include a power supply that receives input power directly from or derived from an alternating current (AC) source (e.g., an AC source whose power is communicated via an AC wall voltage) and provides power to one or multiple primary power supply lines 145 (e.g., supply voltage rails of the computer platform 100) when the AC power is available.

Depending on the particular implementations, the primary power source 144 may be part of the computer platform 100 (as depicted in FIG. 1) or may be separate from the computer platform 100. For example, in accordance with some implementations, the computer platform 100 may be a blade server, and the primary power source 144 may include a power distribution unit (PDU) for a rack that contains the blade server. The primary power source 144 may, in accordance with further implementations, includes components of the computer platform 100 and components that are not part of the computer platform 100. As depicted in FIG. 1, in accordance with example implementations, the RTC devices 180 may be coupled to one or multiple primary supply lines 145 for purposes of receiving primary power, when available.

An RTC device state back-up system 138 of the computer platform 100, in accordance with example implementations, maintains non-volatile snapshots 140 of states of the RTC devices 180 so that, if a primary power outage occurs, the RTC device state back-up system 138 uses the snapshots 140 to restore the states when the primary power outage ends. A given state (e.g., a time-of-day or calendar date) of an RTC device 180 may be time-based, and the RTC device state back-up system 138 may use the corresponding snapshot 140 of the given state, in conjunction with a ToB (provided by a ToB timer 136), to restore the given state when the primary power outage ends. Other states (e.g., volatile memory contents) of the RTC devices 180 may not be time-based, and the RTC back-up system 138 may restore these states based on the corresponding snapshots 140.

As depicted in FIG. 1, in accordance with example implementations, the RTC device state back-up system 138 includes a non-volatile storage 134 that stores data representing the snapshots 140. In accordance with example implementations, certain components of the RTC device state back-up system 138, such as the non-volatile storage 134, an address decoder, shadow registers 133, and the ToB timer 136, may receive alternate power (called “secondary power” herein) from a secondary power source 148. The non-volatile storage 134 survives a loss of power from the primary power source 144. The non-volatile storage 134 may or may not be formed from non-volatile memory devices, depending on the particular implementation. In an example, the non-volatile storage 134 may include volatile memory devices that are powered by secondary power, and therefore, the volatile memory devices retain their stored data when a primary power loss occurs, as long as the secondary power is uninterrupted. In another example, the non-volatile storage 134 may include non-volatile memory devices (e.g., flash memory devices, ROM devices, phase change memory devices, memristor memory devices, or memory devices corresponding to another non-volatile memory device technology).

The secondary power source 148, in accordance with example implementations, contains a stored back-up energy source, such as a battery 149, which directly or indirectly provides the secondary power. In this manner, as depicted in FIG. 1, in accordance with example implementations, the secondary power source 148 may provide power to one or multiple secondary power supply lines 150 (secondary power voltage rails of the computer platform 100), which are coupled to components of the RTC back-up system 138. In accordance with some implementations, the secondary power source 148 may include a DC-to-DC converter, as well as power conditioning components.

The battery 149 may be, as examples, a rechargeable battery, such as a lithium-ion battery, or a non-rechargeable battery, such as a coin cell battery. In accordance with further implementations, a non-battery-based stored energy source may be used in place of the battery 149, such as, for example, a supercapacitor. For implementations in which the stored energy source is rechargeable (e.g., the stored energy source is a supercapacitor or rechargeable battery), the secondary power source 148 may use primary power that is derived from the primary power source 144 to charge the stored energy source when the primary power is available. Regardless of the particular stored energy source that is used to provide secondary power, in accordance with example implementations, due to the space and cost efficiencies provided by the RTC device state back-up system 138, the stored energy source is sized for a single RTC device 180, although the stored energy source provides secondary power that is used to back-up multiple RTC devices 180.

The RTC device time indications (e.g., time-of-day indications and calendar date indications) that are provided by the RTC devices 180 may at any particular moment differ and in general, may be independent of one another. This may be attributable to different hosts 101 (which operate independently of one another in different respective time domains) initializing the time values for the respective RTC devices 180 at different times. For example, the different hosts 101 may be providing services to different respective geographical locations, and consequently, at least some of the hosts 101 may be operating in different time zones. Moreover, the time formats used by the RTC devices 180 may vary. For example, the time-of-day format (e.g., a binary coded decimal format, a twenty-four-hour time format or other format) for one RTC device 180 may be different than the time-of-day format for another RTC device 180. As described further herein, in accordance with example implementations, the RTC device state back-up system 138 maintains the snapshots 140 for the associated RTC devices 180 in a manner that accommodates the differences in the time formats of the different RTC devices 180. Moreover, the RTC device state back-up system 138, in accordance with example implementations, keeps track of the different time formats so that the restoration of the RTC devices 180 after a power outage preserves the time formats.

For the example implementation that is depicted in FIG. 1, the RTC device state back-up system 138 is part of the BMC 129. In accordance with some implementations, components of the RTC back-up system 138 may be part of the semiconductor package 153 that contains the RTC devices 180. In accordance with some implementations, components of the RTC device state back-up system 138 may be fabricated on the same semiconductor die of the semiconductor package 153 as components of the RTC devices 180. As another example, in accordance with some implementations, components of the RTC device state back-up system 138 may be fabricated on different semiconductor die of the semiconductor package 153. In accordance with further implementations, components of the RTC device state back-up system 138 may be part of a semiconductor package of the BMC 129 other than the semiconductor package 153. Moreover, in accordance with further implementations, components of the RTC device state back-up system 138 may be part of a standalone semiconductor package, which is not part of the BMC 129. In accordance with further implementations, components of this standalone semiconductor package may also include the RTC devices 180 or components of the RTC devices 180.

In accordance with example implementations, the BMC 129 may execute a set of firmware instructions, called a “firmware management stack,” for purposes of providing a variety of management services for the hosts 101 of the computer platform 100 as part of the BMC's management plane. In accordance with example implementations, the BMC 129 may independently provide management services for each host 101.

As examples, the BMC 129 may provide such management services as monitoring sensors; monitoring operating system status; monitoring power statuses; logging computer system events; providing a remote console; providing remotely-controlled functions and other virtual presence technologies; and other management activities. In accordance with example implementations, the BMC 129 may communicate with a remote management server 190 (e.g., a server that may or may not be located in the same data center as the computer platform 100 or a server that is located at a different geographical location than the computer platform 100) via a network interface controller (NIC) 158 of the BMC 129. In accordance with further implementations, the BMC 129 may communicate with the remote management server 190 via a NIC 124 through a sideband bus 127 (e.g., a bus corresponding to a Network Controller Sideband Interface (NC-SI) electrical interface and protocol defined by the Distributed Management Task Force (DMTF)), which is coupled to a bus communication interface 156 of the BMC 129.

The management services that are provided by the BMC 129 may include remotely-management functions, i.e., functions that may be managed by the remote management server 190. As examples, the remotely-managed functions may include keyboard video mouse (KVM) functions; virtual power functions (e.g., remotely activated functions to remotely set a power state, such as a power conservation state, a power on, a reset state or a power off state); virtual media management functions; and one or multiple other management-related functions for a given host 101.

In accordance with example implementations, the BMC 129 includes one or multiple main management processing cores 154 (called “main processing cores 154” herein), such as CPU cores, that execute machine-readable instructions to provide management services for the hosts 101. These instructions may correspond to a firmware management stack of the BMC 129. In accordance with some implementations, the main processing cores 154 may execute machine-readable instructions that are validated and loaded into a main memory 159 (e.g., a memory outside of the semiconductor package 153) of the BMC 129 by a security processor 130 of the BMC 129.

The security processor 130, in accordance with example implementations, provides security services that are part of the BMC's security plane, which is isolated from the BMC's management plane. In general, the security processor 130 provides cryptographic services and protects the computer platform 100 and host(s) 101 against security attacks. As examples, the security services may validate at least an initial portion of firmware 170 that is stored in a non-volatile memory 168 of the computer platform 100 and loaded into a memory 155 of the BMC 129. More specifically, in accordance with some implementations, the BMC 129 may include a silicon Root-of-Trust (SRoT), and the security processor 130 may extend a chain of trust from the SRoT to the firmware management stack that is executed by the BMC's main management processing cores 154. The security processor 130 may perform various other security services for the computer platform 100 and hosts 101. As examples of security services, the security processor 130 may detect tampering; generate random or pseudo random numbers; store measurement digests; sign measurement digests; store measurement hashes; load reference measurement hashes; store cryptographic keys, retrieve cryptographic keys, generate cryptographic keys, validate firmware image; retrieve a cryptographic platform identity, create certificates, store certificates, add certificates, delete certificates, seal cryptographic keys, unseal cryptographic keys and provide other security-related services.

A “host” (or “host instance”) refers to a logical instance of a computing platform. The logical instance is associated with resources, such as one or multiple processors, a memory and one or multiple peripherals. As examples, the processor may be one or multiple central processing unit (CPU) cores. The memory may be a system memory or other memory, and the peripheral(s) may include one or multiple RTC devices, such as an RTC device 180.

For the example implementation that is depicted in FIG. 1, the resources for a host 101 may include one or multiple main CPU cores 102 (e.g., the CPU cores of a particular CPU package, or socket) and memory devices that are connected to the CPU core(s) 102 to form a system memory 104. The CPU core(s) 102 may be coupled to one or multiple input/output (I/O) bridges 106, which allow communications between the CPU core(s) 102 and the BMC 129 (via one or multiple bus communication interfaces 156 of the BMC 129), as well as communications with various I/O devices, such as storage drives 122; one or multiple network interface controllers (NICs) 124; one or multiple Universal Serial Bus (USB) devices 126; I/O devices; a video controller; and so forth. Moreover, as also depicted in FIG. 1, the computer platform 100 may include one or multiple Peripheral Component Interconnect Express (PCIe) devices 110 (e.g., PCIe expansion cards) that may be coupled to the CPU core(s) 102 through corresponding individual PCIe bus(es) 108. In accordance with a further example implementation, the PCIe device(s) 110 may be coupled to the I/O bridge(s) 106, instead of being coupled to the CPU core(s) 102. In accordance with yet further implementations, the I/O bridge(s) 106 and PCIe interfaces may be part of the CPU core(s) 102. In accordance with yet further implementations, the I/O bridge(s) 106 and PCIe interfaces may co-exist within a semiconductor package containing one or multiple die. In accordance with example implementations, the host 101 may include CXL fabric to couple the CPU core(s) 102 to high speed coherent and non-coherent peripherals.

In general, the memory devices that form the system memory 104, as well as other memories and storage media that are described herein, may be formed from non-transitory memory devices, such as semiconductor storage devices, flash memory devices, memristors, phase change memory devices, a combination of one or more of the foregoing storage technologies, and so forth. Moreover, the memory devices may be volatile memory devices (e.g., dynamic random access memory (DRAM) devices, static random access (SRAM) devices, and so forth) or non-volatile memory devices (e.g., flash memory devices, read only memory (ROM) devices and so forth), unless otherwise stated herein.

In accordance with some implementations, one or multiple NICs 124 of the computer platform 100 may be intelligent input/output peripherals, or “smart I/O peripherals,” which may provide backend I/O services for one or multiple applications 115 (or application instances) that execute on the computer platform 100. In accordance with some implementations, one or multiple of the PCIe devices 110 may be smart I/O peripherals.

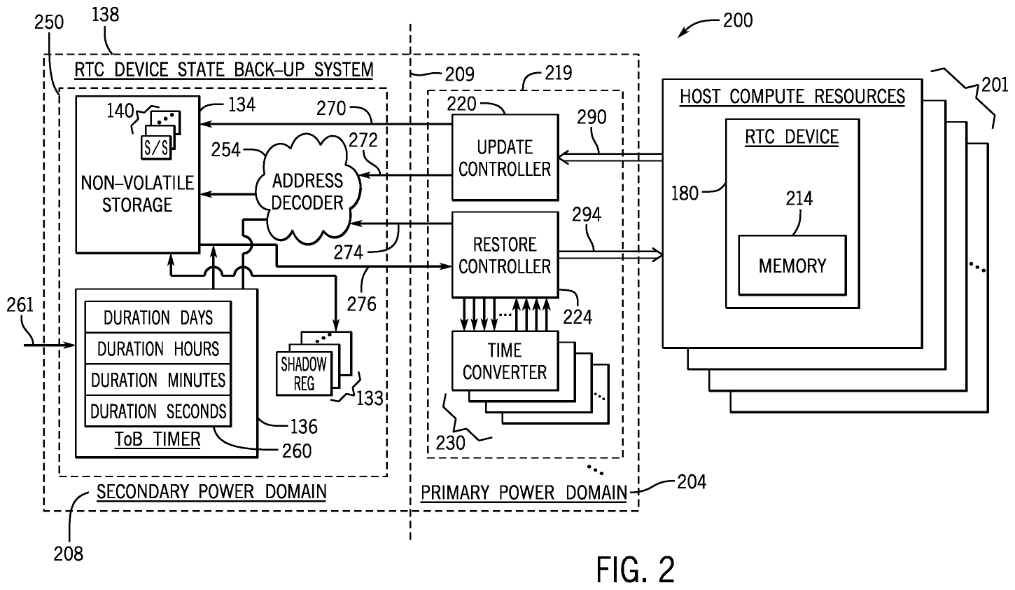

FIG. 2 is a block diagram of a multiple host system 200, in accordance with example implementations. Referring to FIG. 2, the multiple host system 200 includes sets 201 of host compute resources, which may be collectively provided by a single computer platform and which individually provide respective hosts. In accordance with example implementations, each set 201 of compute resources includes an RTC device 180 for an associated host. In addition to having memory locations (e.g., register memory locations) that store data related to time-based states (e.g., time-of-day and calendar date states), the RTC device 180 may also include, in accordance with example implementations, a volatile memory 214, which stores content (e.g., configuration data, such as BIOS configuration parameters) for the computer platform. In this context, the “volatile memory 214” refers to a memory of the RTC device 180, which does not retain its stored contents when power to the memory is removed. In an example, the volatile memory 214 may be powered by a primary power source (described further herein), and as such, the volatile memory 214 may lose its stored contents when primary power is interrupted. As depicted in FIG. 2, in accordance with example implementations, the system 200 includes an RTC device state back-up system 138.

In accordance with example implementations, the RTC device state back-up system 138 is partitioned (as depicted at 209) into two power domains: a primary power domain 204 and a secondary power domain 208. As such, some components 219 of the RTC device state back-up system 138 are located in the primary power domain 204 and receive power from a primary power source (and do not receive secondary power), and other components 250 of the RTC device state back-up system 138 are located in the secondary power domain and receive power from a secondary power source (and do not receive primary power).

In accordance with example implementations, the RTC device state back-up system 138 includes an update controller 220, which is located in the primary power domain 204. The update controller 220, in accordance with example implementations, is coupled to the RTC devices 180 via a communication interface 290 (e.g., a communication interface provided via a Serial Peripheral Interface (SPI) bus, an Inter-Integrated Circuit (I²C) bus, an Improved I²C (I3C) bus, or another bus or communication interface). The update controller 220, in accordance with example implementations, may be coupled to data and control signal lines 270 that are coupled to the non-volatile storage 134, and the update controller 220 may be coupled to address and control lines 272 that are coupled to an address decoder 254. The address decoder 254 and the non-volatile storage 134, as depicted in FIG. 2, may be located in the secondary power domain 208.

The update controller 220, in accordance with example implementations, is enabled when primary power is available, for purposes of maintaining the state snapshots 140 of the RTC devices 180. As part of maintaining the snapshots 140, the update controller 220 writes to locations in the non-volatile memory 140 corresponding to the different states that have changed from the previously stored states, and the update controller 220 repeatedly updates the data stored in the locations (e.g., repeatedly writes to the locations) so that when primary power is available, the snapshots 140 represent the current, or most recent, states of the RTC devices 180.

The update controller 220 may be informed when state changes occur in the RTC device states in one of many different ways, depending upon the particular implementation. For example, in accordance with some implementations, the update controller 220 may receive an interrupt that is provided by an RTC device 180 when a particular state of the RTC device 180 changes (e.g., a time-of-day indication change, a calendar date indication change, a write occurs to the volatile memory 214 of the RTC device, or another state change). The update controller 220 may, responsive to the interrupt, read data from the RTC device 180 corresponding to the interrupt and write data representing the read data to the location in the non-volatile storage 134, which corresponds to the appropriate snapshot 140. As another example, in accordance with further implementations, the update controller 220 may poll certain storage locations (e.g., registers) of a particular RTC device 180 for purposes of determining when a corresponding state of the RTC device 180 changes. As another example, in accordance with further implementations, the update controller 220 may intercept updates (e.g., snoop write data) to certain storage locations (e.g., registers) of a particular RTC device 180 for purposes of determining when a corresponding state of the RTC device 180 changes.

As depicted in FIG. 2, in accordance with example implementations, the ToB timer 136 is associated with the secondary power domain 208, i.e., the ToB timer 136 receives power from a secondary power source. The ToB timer 136 counts to provide a count value that represents an accumulated time that is measured from the time beginning when loss of primary power is detected. The accumulated time may be referenced to a reset count of the ToB timer 136, and the ToB timer 136, as further described herein, may reset in response to the primary power being restored.

The ToB timer 136, in accordance with example implementations, has a trigger input 261 that causes the ToB timer 136 to begin counting in response to the beginning of a primary power outage. For example, in accordance with some implementations, the trigger input 261 may receive a primary power good signal, which transitions to a certain signal state to represent the beginning of a period of time in which the primary power is unstable or unavailable. As depicted in FIG. 2, in accordance with some implementations, an output 260 (e.g., data in one or multiple registers) of the ToB timer 136 may be partitioned into seconds, minutes, hours and days. In accordance with example implementations, the output 260 represents the time (called an “accumulated time” herein) that has elapsed from the time when the primary power outage began. It is noted that, in accordance with example implementations, the resetting of the ToB timer 136 may be controlled by a restore controller 224 of the RTC device state back-up system 138. As such, the ToB timer 136 may continue counting (e.g., the accumulated time may continue to increase) when primary power is available, which may be beneficial in the state restoration process, as further described herein.

In accordance with example implementations, the restore controller 224 resides in the primary power domain 204, and, responsive to the primary power being restored after a primary power outage, the restore controller 224 takes actions to restore the states of the RTC devices 180. For example, in accordance with some implementations, responsive to a primary power outage ending (e.g., responsive to a primary power good signal transitioning to a state representing that stable primary power is available), the restore controller 224 reads snapshots 140 corresponding to the last stored time-of-day indications and calendar date indications for the respective RTC devices 180. The restore controller 224 adjusts the times-of-day indications (and possibly adjusts the calendar date indications, depending on the length of the primary power outage) based on the accumulated time that is provided by the ToB timer 136. Moreover, the restore controller 224, in accordance with example implementations, may use one or multiple time converters 230 in the state restoration process to accommodate the time formats used by the RTC devices 180, as further described herein.

After the restore controller 224 determines adjusted times-of-day and determines adjusted calendar dates, the restore controller 224 may then cause data to be written to the RTC devices 180 to restore the states of the RTC devices 180. In performing this process, the restore controller 224 may use shadow registers 133.

The restore controller 224 may read data from the non-volatile storage 134 representing snapshots of non-time-based states (e.g., content corresponding to snapshots of the volatile memories 214) and write the data to the RTC devices 180 to restore these states. In accordance with example implementations, the restore controller 224, in response to the updates to the RTC devices 180 being complete, resets the ToB timer 136 and releases a hold on the update controller 220 (e.g., releases a hold that keeps the update controller 220 in reset after a primary power is restored), which allows the update controller 220 to maintain the snapshots 140.

As depicted in FIG. 2, in accordance with example implementations, the restore controller 224 may be coupled by a communication interface 294 (e.g., a communication interface provided by an SPI bus, I2C bus, I3C bus, another bus or another communication interface) to the RTC devices 180. The restore controller 224, in accordance with example implementations, may be coupled to data and control signal lines 276 that are coupled to the non-volatile storage 134 and address and control lines 274 that are coupled to an address decoder 254.

In accordance with example implementations, the restore controller 224 begins the state restoration process by sampling the ToB. More specifically, in accordance with some implementations, the restore controller 224 reads and latches the output 260 of the ToB timer 136. In this context, “latching” the output 260 refers to the restore controller 224 storing the read value as a fixed ToB. The ToB timer 136, in accordance with example implementations, may continue to count after being read by the restore controller 224, until the ToB timer 136 is reset by the restore controller 224. The continued counting by the ToB timer 136 may be advantageous if a more recent ToB is to be used, as further described herein.

In accordance with some implementations, the update controller 220 may include one or multiple processing cores (e.g., CPU cores) that execute machine-readable instructions (e.g., instructions that are stored in a memory of the update controller 220) for purposes of performing functions (e.g., writing data to non-volatile storage representing RTC device snapshots) of the update controller 220. In accordance with some implementations, the update controller 220 may contain hardware circuitry that does not execute machine-readable instructions and performs some or all of the functions of the update controller 220. For example, in accordance with some implementations, the update controller 220 may be or include an application specific integrated circuit (ASIC). In accordance with some implementations, the update controller 220 may be or include a programmable logic device, such as a field programmable gate array (FPGA) or a complex programmable logic device (CPLD).

In accordance with some implementations, the restore controller 224 may include one or multiple processing cores (e.g., CPU cores) that execute machine-readable instructions (e.g., instructions that are stored in a memory of the restore controller 224) for purposes of performing functions of the restore controller 224, such as calculating adjusted RTC times and dates, reading the ToB, writing to registers of RTC devices with updated times and dates, and writing to volatile memories of RTC devices with previously stored snapshots of the memory content. In accordance with some implementations, the restore controller 224 may contain hardware circuitry that does not execute machine-readable instructions and performs some or all of the functions of the restore controller 224. For example, in accordance with some implementations, the restore controller 224 may be or include an ASIC. In accordance with some implementations, the restore controller 224 may be or include a programmable logic device, such as an FPGA or CPLD.

In accordance with some implementations, the time converter 230 may include one or multiple processing cores (e.g., CPU cores) that execute machine-readable instructions (e.g., instructions that are stored in a memory of the restore controller 224) for purposes of converting data representing a first time and associated with the first format into data representing a second time corresponding to a second format. In accordance with some implementations, the time converter 230 may contain hardware circuitry that does not execute machine-readable instructions and performs some or all of the functions of the time converter 230. For example, in accordance with some implementations, the time converter 230 may be or include an ASIC. In accordance with some implementations, the time converter 230 may be or include a programmable logic device, such as an FPGA or CPLD. In accordance with some implementations, the restore controller 224 may execute machine-readable instructions or may include dedicated hardware circuitry corresponding to the time converters 230 (i.e., the time converters 230 may be incorporated into the restore controller 224).

In accordance with example implementations, each shadow register 133 is used by the restore controller 224 as a mechanism to update the time and date portion of a snapshot 140, and the restore controller 224 updates the shadow registers 133 while the times and dates are being restored inside the respective RTC devices 180. The shadow registers 133 provide a parallel way to update the time and date portions of the snapshots 140 during the same clock in which the ToB timer 136 is reset. In accordance with example implementations, data is not copied from the shadow registers 133 to the RTC devices 180. Rather, the restore controller 224 writes to both the memories 214 of the RTC devices 180 and the shadow registers 133 as the restore controller 224 is performing the time and date conversions. When the time and date conversions are complete, the primary copies of the time and date data stored in the memories 214 are the same as the shadow copies of the time and date data stored in the corresponding shadow registers 133. This allows a seamless transfer of all time and date data in parallel from the shadow registers 133 to the time and date portions of the snapshots 140, reset the ToB timer 136, and enablement of the update controller 220 for future updates.

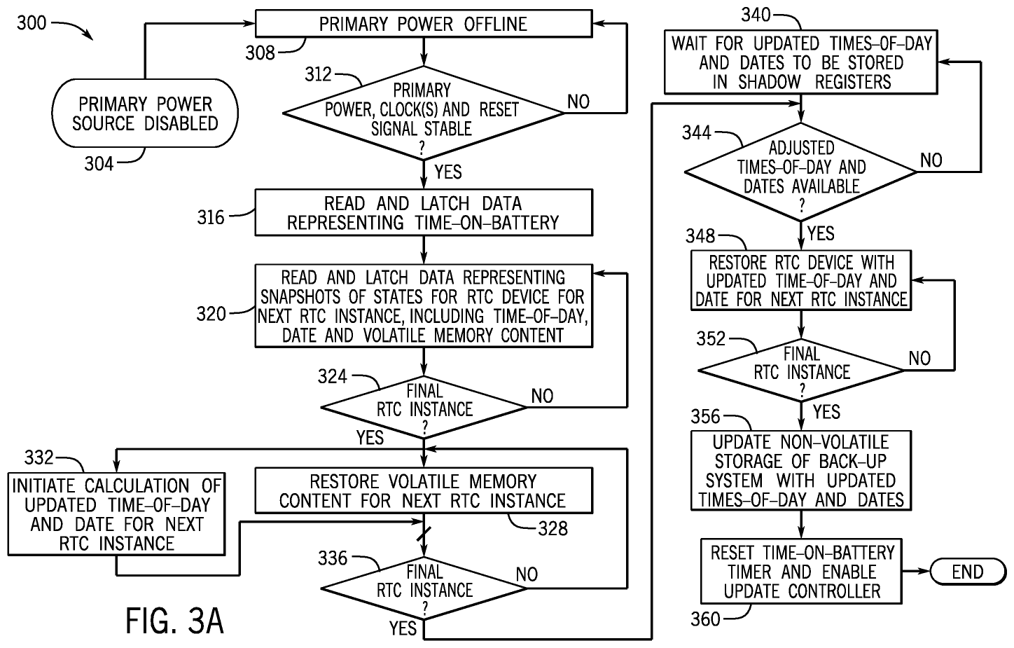

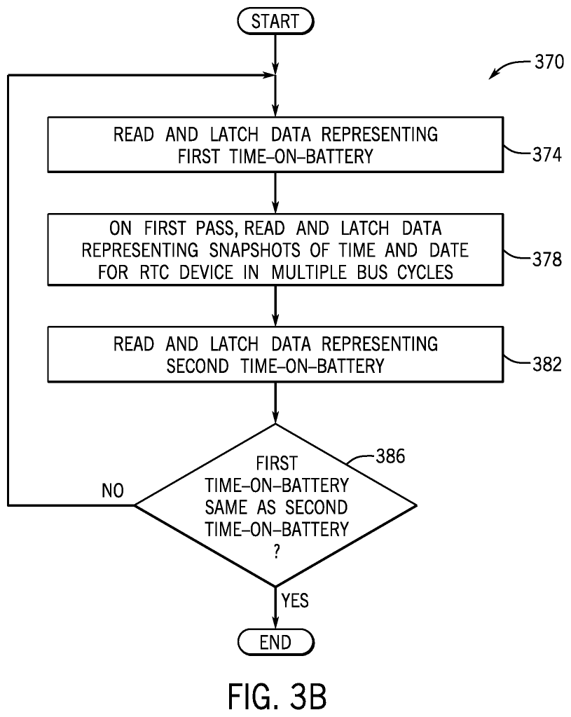

FIG. 3A depicts a process 300 used to restore states of the RTC devices 180 in accordance with example implementations. In an example, the process 300 may be performed by a restore controller, such as the restore controller 224 of FIG. 2. Referring to FIG. 3A, the process 300 is initiated, in accordance with example implementations, in response to a primary power source for the computer platform being disabled, pursuant to block 304, such that the primary power is offline, pursuant to block 308.

The restore controller, in accordance with example implementations, receives primary power, and as such, the restore controller may remain powered down after a primary power outage until the primary power, clock(s), reset signal associated with the restore controller are once again stable, as depicted in decision block 312. When these criteria are met, the restore controller is released from reset and begins to perform actions to restore the states of the RTC devices, beginning with block 316. In accordance with example implementations, an update controller, such as the update controller 220 of FIG. 2, which is powered by the primary power source, is held in reset while the restore controller is released from reset, and the update controller remains in reset until released by the restore controller, as described herein.

Although blocks 316-360 of FIG. 3A depict a sequential flow of actions, some or all of these actions may be performed in parallel and/or in a different order than the order that is depicted in FIG. 3A, in accordance with further implementations.

The process 300 includes, pursuant to block 316, reading and latching data representing the current ToB. Pursuant to block 320, the process 300 includes reading and latching data that represents a snapshot of RTC states for a particular RTC instance. Pursuant to decision block 324 of process 300, if another RTC instance is to be processed, then control returns to block 320.

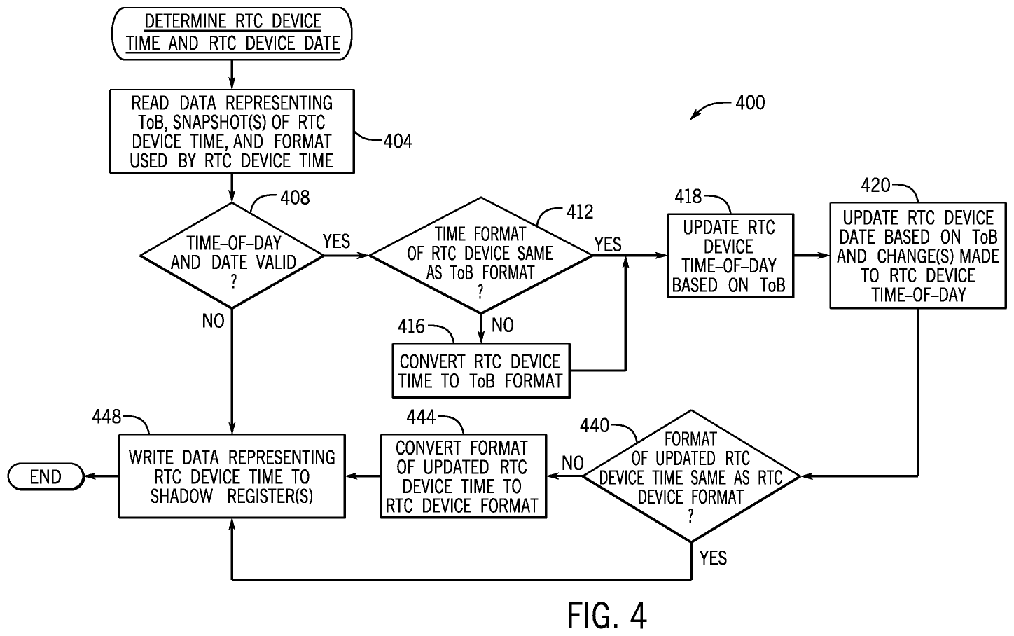

After the ToB data and snapshot data are obtained, the process 300 includes initiating (block 332) the calculation of the updated time and date for the current RTC instance and restoring (block 328) the volatile memory content of the RTC device. As depicted in FIG. 3A, the process 300 may include performing blocks 328 and 332 in parallel. In accordance with example implementations, the calculation of the updated time and date may be performed in parallel with other actions of the process 300. FIG. 4, which is described below, depicts a specific example of a process 400 to calculate the updated time and date, in accordance with example implementations. Still referring to FIG. 3A, pursuant to block 328, the process 300 includes restoring the volatile memory content by writing the snapshot data corresponding to the content to the volatile memory of the RTC device. If, pursuant to decision block 336, another RTC device for another RTC instance is to be processed, then control returns to blocks 328 and 332.

In accordance with example implementations, for purposes of ensuring that the read snapshot data is not corrupted if a primary power loss occurs during the RTC state restoration, the process 300 writes data representing the calculated updated time and dates to shadow registers (e.g., shadow registers 133 depicted in FIGS. 1 and 2), which are in the secondary power domain. The process 300 includes waiting (decision block 340 and block 344) for the updated time and date for each RTC instance to be written to the corresponding shadow registers. When this occurs, the process 300 begins updating, pursuant to block 348, the time and date portions of the RTC devices to complete the restoration of the RTC states. Pursuant to decision block 352, each RTC instance is processed until all states are restored.

The process 300 next includes, in accordance with example implementations, updating the non-volatile storage of the RTC device back-up system with the updated time and date states, as depicted in block 356. In this manner, the process 300 includes updating the snapshots in the non-volatile storage representing the now current RTC times and dates using the shadow registers (e.g., the shadow registers 133 of FIG. 2) that were updated in block 340. The shadow registers provide a parallel way to update the time and date portions of the snapshots during the same clock in which the ToB timer (e.g., the ToB timer 136 of FIG. 2) is reset, which prevents data loss in the event of an additional power outage. Pursuant to block 360, the process 300 includes resetting the ToB timer and enabling the update controller, so that the update controller may begin maintaining the snapshots.

In accordance with example implementations, the ToB timer keeps running and may increment while the data that represents the ToB is read from the ToB timer in multiple consecutive reads using multiple bus cycles (i.e., a part of the ToB is read in each bus cycle). It is possible that the ToB timer may update the ToB between consecutive reads. This means that a particular ToB value that is derived using multiple reads of the ToB timer may have one of three states: invalid, stale or valid. In an example, multiple reads of the ToB timer may result in a ToB value that is “torn” and therefore invalid. For example, if the ToB value is read in two consecutive reads, the first read may correspond to the seconds portion of the ToB, and the second read may correspond to the minutes portion of the ToB. The ToB at the time of the first read may be 1 minute and 59 seconds. If the ToB increments by one second between the first and second reads, then the ToB value constructed from both reads is 2 minutes and 59 seconds, which is invalid. In another example, multiple reads of the ToB timer may results in a stale ToB value. For example, the ToB at the time of the first read may be 1 minute and 32 seconds, the ToB at the time of the second read may be 1 minute and 33 seconds and two consecutive reads may be used to derive the ToB value. The first read may retrieve a ToB second value of 32 seconds, and the second read may retrieve a ToB minute value of 1 minute. Therefore, for this example, the ToB value derived by the two reads is 1 minute and 32 seconds, although the ToB at the time of the second read was actually 1 minute and 33 seconds.

For purposes of ensuring that a ToB value that is derived using multiple consecutive reads of the ToB timer is valid (e.g., not torn or stale), the restore controller rereads the ToB time (each via multiple consecutive reads) until the last two ToB values are the same. More specifically, in accordance with example implementations, the restore controller may perform a process 370 that is depicted in FIG. 3B for purposes of reading the ToB timer.

Referring to FIG. 3B, pursuant to block 374, the process 370 includes reading and latching data representing a first ToB. Next, the process 370 may include reading and latching data representing the snapshots of the time and date for the RTC device in multiple bus cycles, pursuant to block 378. Although the ToB timer is incrementing and therefore, the ToB is dynamic in nature, the snapshot data is static, and as such, the process 370 includes performing block 378 in the first pass (of potentially multiple passes but) not performing the block 378 in any subsequent pass that is used to derive a valid ToB value. The process 370 next includes reading (block 382) and latching data representing a second ToB. If, pursuant to decision block 386, the first ToB and second ToB are not the same, then another iteration of the process 370 is used to read two ToB values, pursuant to blocks 374 and 382. If, pursuant to block 386, the two ToB values are the same, then the ToB value is considered valid and the process 370 terminates.

FIG. 4 depicts a process that may be performed by the restore controller 224 to calculate, or determine, an updated time-of-day and date for a given RTC device, in accordance with example implementations. The process 400 may be initiated in block 332 of FIG. 3A, in accordance with example implementations.

Referring to FIG. 4, pursuant to block 404, the process 400 includes reading data representing the ToB, the snapshots of the time and date, and the time format used by the RTC device. FIG. 4 depicts the processing of an RTC device time, beginning an RTC time and date represented by snapshot(s) and ending with a calculated RTC device time and final RTC device date, called the “updated RTC device time” and “updated RTC device date,” respectively. Pursuant to decision block 408, a determination is made whether the snapshot is valid. In this manner, in accordance with some implementations, a particular host 101 may update the RTC device with a time and date after a power outage, and as such, the RTC device time and date stored by the corresponding snapshot(s) are invalid and are not updated by the process 400.

If the RTC device time and RTC device date derived from the snapshot(s) are valid, then, pursuant to decision block 412, the process 400 includes determining whether the time format used by the RTC device is same as the ToB format. If not, the process 400 includes converting (block 416) the RTC device time from the RTC device format to the ToB format. Next, the process 400 includes updating (block 418) the RTC device time-of-day based on the ToB and updating (block 420) the RTC device calendar date (e.g., a day of the week, a day of the month and year) based on the ToB and change(s) made to the RTC device time-of-day.

As an example, the ToB may be 35 seconds, and the snapshot calendar date and time-of-day may be the following: Thursday, Jun. 24, 2004, 08:45:42, in a 24 hour (hour: minute: second) format. The corresponding adjusted RTC device calendar date and time-of-day for this example is Thursday, Jun. 24, 2004, 8:46:17. As another example, the ToB may be 58 seconds, and the snapshot calendar date and time-of-day may be the following: Friday, Dec. 31, 1999, 23:59:56. The corresponding adjusted RTC calendar date and time-of-day for this example is Saturday, Jan. 1, 2000, 00:00:54.

Next, pursuant to decision block 440, the process 400 includes determining whether the format of the updated RTC time is the same as the format of the RTC device, and if not, the process 400 includes converting (block 444) the format of the updated RTC device time to the format of the RTC device. The process 400 includes, pursuant to block 448, writing data to the appropriate shadow register(s) representing the updated RTC device time and updated RTC device date.

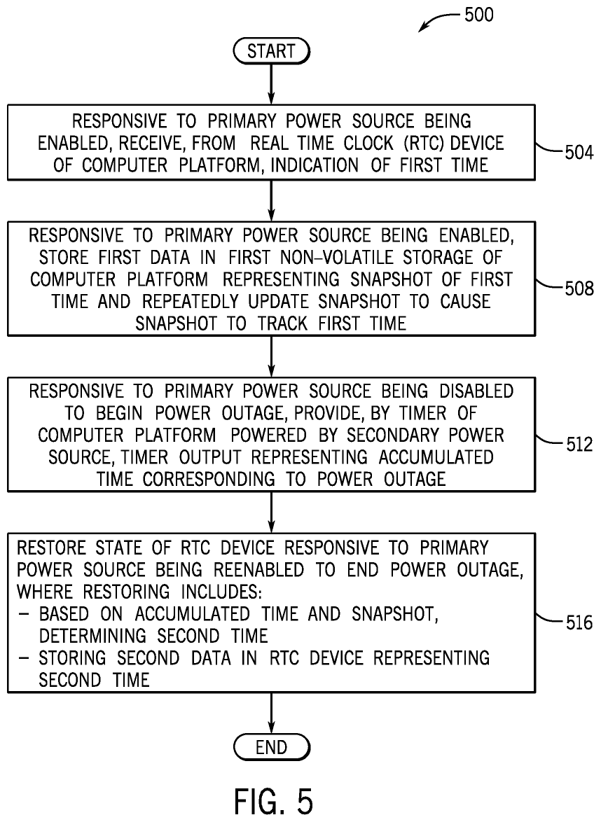

Referring to FIG. 5, in accordance with example implementations, a process 500 includes, responsive to a primary power source being enabled, receiving (block 504), from a real time clock (RTC) device of a computer platform, an indication of a first time. The first time may be a time-of-day, in accordance with example implementations. In accordance with some implementations, the RTC device may correspond to a host (e.g., an operating system instance) of the computer platform. In accordance with some implementations, the RTC device may be a hardware RTC device, which is part of a management controller (e.g., a baseboard management controller) of the computer platform.

The process 500 includes, pursuant to block 508 and responsive to the primary power source being enabled, storing first data in a first non-volatile storage of the computer platform representing a snapshot of the first time and repeatedly updating the snapshot to cause the snapshot to track the first time. In an example, the non-volatile storage may include volatile memory devices that are powered by a secondary power source. In an example, the non-volatile storage may include non-volatile memory devices. Responsive to the primary power source being disabled to begin a power outage, the process 500 includes providing (block 512) by a timer of the computer platform powered by a secondary power source, a timer output that represents an accumulated time that corresponds to the power outage. In accordance with some implementations, the timer may be part of a secondary power domain, may be reset responsive to the primary power source being enabled, and may count responsive to the beginning of a primary power outage

The process 500 includes restoring (block 516) a state of the RTC device responsive to the primary power source being reenabled to end the power outage. The restoration includes, based on the accumulated time and the snapshot, determining a second time, and storing second data in the RTC device that represents the second time. The second time may be a time-of-day, in accordance with example implementations. In accordance with example implementations, restoring the state of the RTC device may include restoring a second date and/or restoring a memory content of the RTC device.

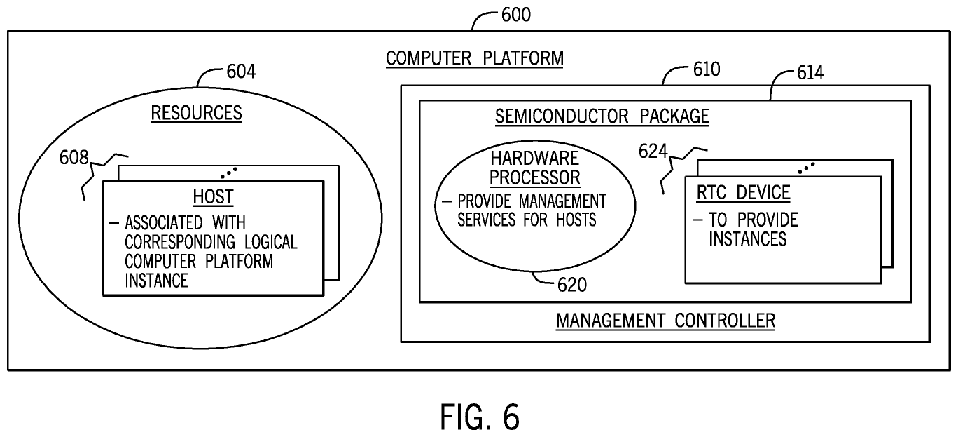

Referring to FIG. 6, in accordance with example implementations, a computer platform 600 includes resources 604 to provide a plurality of hosts 608; and a management controller 610. In an example, the resources 604 may include machine-readable instruction-based (or “software-based”) components and physical hardware components. Each host 608 may be associated with a logical computer platform instance. The management controller 610, in accordance with example implementations, may be specialized service processor that monitors the physical state of a server or other hardware using sensors and communicates with a management system through a management network.

In accordance with example implementations, the management controller may be a baseboard management controller. In accordance with example implementations, the computer platform 600 may be a modular unit that may include hardware that is mounted to the chassis and is capable of executing machine-readable instructions. As examples the computer platform 600 may a blade server, a rack-mounted server, a standalone server, a client, a desktop, a smartphone, a wearable computer, a networking component, a gateway, a network switch, a storage array, a portable electronic device, a portable computer, a tablet computer, a thin client, a laptop computer, a television, a modular switch, a consumer electronics device, an appliance, an edge processing system, a sensor system, a watch, a removable peripheral card, or, in general, any other processor-based platform.

The management controller 610 includes a semiconductor package 614. The semiconductor package 614 includes a hardware processor 620 and a plurality of hardware real time clock (RTC) devices 624 that provide RTC instances. The RTC devices 624 may be fabricated on one or multiple dies of the semiconductor package 614. The RTC device 624, in accordance with example implementations, may provide data that represents a time (e.g., a time in terms of an hour, minute and second) and calendar date (e.g., a date in terms of a year, month and day), which correspond to the rotational cycles of the Earth. A given RTC instance may correspond to a host instance in that the RTC instance measures times for the host instance. A given RTC instance may measure time for the management controller 610.

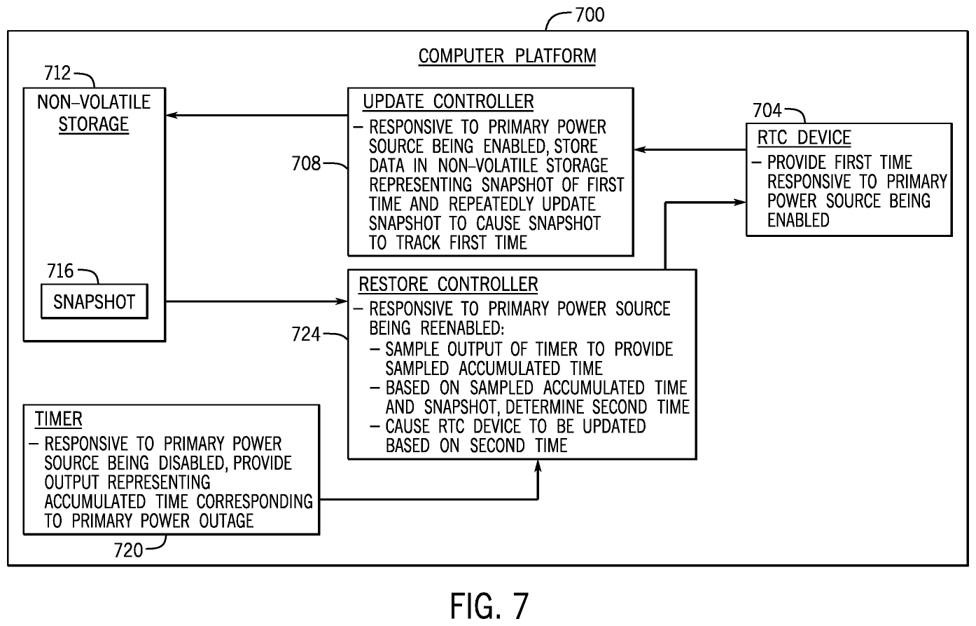

Referring to FIG. 7, in accordance with example implementations, a computer platform 700 includes a real time clock (RTC) device 704; a non-volatile storage 712; an update controller 708; a timer 720; and a restore controller 724. In accordance with example implementations, the RTC device may provide data that represents a time (e.g., a time in terms of an hour, minute and second) and calendar date (e.g., a date in terms of a year, month and day), which correspond to the rotational cycles of the Earth. In an example, the non-volatile storage 712 may include non-volatile memory devices. In another example, the non-volatile storage 712 may include volatile memory devices that are powered by a secondary power source. In accordance with example implementations, the non-volatile storage 712 and the timer 720 may be associated with a secondary power domain. In accordance with example implementations, the update controller 708 may include one or multiple processing cores that execute machine readable instructions to perform one or multiple functions of the update controller 708. In accordance with example implementations, the update controller 708 may contain dedicated hardware circuitry (e.g., an ASIC, FPGA or CPLD) to perform one or multiple functions of the update controller 708.

In accordance with example implementations, the restore controller 724 may include one or multiple processing cores that execute machine readable instructions to perform one or multiple functions of the restore controller 724. In accordance with example implementations, the restore controller 724 may contain dedicated hardware circuitry (e.g., an ASIC, FPGA or CPLD) to perform one or multiple functions of the update controller 724. In accordance with example implementations, the update controller 708 and the restore controller 724 may be associated with a primary power domain. In accordance with some implementations, the restore controller 724 may control when the update controller 708 is released from reset, and the restore controller 724 may control when the timer 720 is reset.

The RTC device 704 provides a first time responsive to the primary power source being enabled, stores data in the non-volatile storage 712 representing a snapshot 716 of the first time and repeatedly updates the snapshot 716 to cause the snapshot 716 to track the first time. The timer 720, responsive to the primary power source being disabled, provides an output that represents an accumulated time that the primary power source is disabled. The restore controller 724, responsive to the primary power source being enabled, determines a second time based on the sampled accumulated time and the snapshot; and the restore controller 724 updates the RTC device 704 based on the second time.

In accordance with example implementations, the process includes, responsive to the primary source being enabled, storing third data in a second non-volatile storage of the computer platform representing contents stored in a volatile memory of the RTC device. Restoring the state of the RTC device further includes reading the third data from the second non-volatile storage, and responsive to the reading, storing the third data in the volatile memory. A particular advantage is that a state of an RTC device may be restored after a primary power outage using components that have a relatively small space footprint and associated cost.

In accordance with example implementations, the first time includes a first time-of-day and a first date before the beginning of the power outage, and the second time includes a second time-of-day and a second date. A particular advantage is that a state of an RTC device may be restored after a primary power outage using components that have a relatively small space footprint and associated cost.

In accordance with example implementations, the process includes, responsive to the primary source being enabled, storing third data in a second non-volatile storage of the computer platform representing a snapshot of a first calendar day, which is indicated by the RTC device. Restoring the state of the RTC device further includes reading the third data; and responsive to the reading of the third data, determining an adjustment to be made to the calendar date based on the accumulated time to provide a second calendar date. Restoring the state of the RTC device further includes storing fourth data in the RTC device to cause the RTC device to indicate the second calendar date. A particular advantage is that a state of an RTC device may be restored after a primary power outage using components that have a relatively small space footprint and associated cost.

In accordance with example implementations, restoring the state of the RTC device further includes determining a format that is associated with the first time, and determining the second data based on the format. A particular advantage is that a state of an RTC device may be restored after a primary power outage using components that have a relatively small space footprint and associated cost.

In accordance with example implementations, the restoration further includes reading a first latched representation of the accumulated time and determining the second time based on the first latched representation and the snapshot. A particular advantage is that a state of an RTC device may be restored after a primary power outage using components that have a relatively small space footprint and associated cost.

In accordance with example implementations, the back-up system receives supplementary power from a single stored energy source to maintain the snapshots responsive to the outage of the primary power. A particular advantage is that a state of an RTC device may be restored after a primary power outage using components that have a relatively small space footprint and associated cost.

In accordance with example implementations, the power outage corrupts the states of the RTC devices, and the back-up system further includes a timer to measure a time interval corresponding to the power outage, and the back-up system restores the states based on the time interval and the snapshots. A particular advantage is that a state of an RTC device may be restored after a primary power outage using components that have a relatively small space footprint and associated cost.

In accordance with example implementations, the RTC devices operate independently from each other in respective time domains. A particular advantage is that a state of an RTC device may be restored after a primary power outage using components that have a relatively small space footprint and associated cost.

In accordance with example implementations, the management controller includes a baseboard management controller, the baseboard management controller includes a semiconductor package, and the RTC devices are part of the semiconductor package. A particular advantage is that a baseboard management controller provides a relatively inexpensive and flexible approach to providing RTC devices for multiple hosts on the same computer platform.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
responsive to a primary power source being enabled, receiving, from a real time clock (RTC) device of a computer platform, an indication of a first time;
responsive to the primary power source being enabled, storing first data in a first non-volatile storage of the computer platform representing a snapshot of the first time and repeatedly updating the snapshot to cause the snapshot to track the first time;
responsive to the primary power source being disabled to begin a power outage, providing, by a timer of the computer platform powered by a secondary power source, a timer output representing an accumulated time corresponding to the power outage; and
restoring a state of the RTC device responsive to the primary power source being reenabled to end the power outage, wherein the restoring comprises:
based on the accumulated time and the snapshot, determining a second time; and
storing second data in the RTC device representing the second time.

2. The method of claim 1, further comprising:
responsive to the primary source being enabled, storing third data in a second non-volatile storage of the computer platform representing content stored in a volatile memory of the RTC device,
wherein restoring the state of the RTC device further comprises:
reading the third data from the second non-volatile storage; and
responsive to the reading, storing the third data in the volatile memory.

3. The method of claim 1, wherein the first time comprises a first time-of-day and a first date before the beginning of the power outage, and the second time comprises a second time-of-day and a second date.

4. The method of claim 1, further comprising:
responsive to the primary source being enabled, storing third data in a second non-volatile storage of the computer platform representing a snapshot of a first calendar date indicated by the RTC device,
wherein restoring the state of the RTC device further comprises:
reading the third data;
responsive to the reading of the third data, determining an adjustment to be made to the calendar date based on the accumulated time to provide a second calendar date; and
storing fourth data in the RTC device to cause the RTC device to indicate the second calendar date.

5. The method of claim 1, wherein restoring the state of the RTC device further comprises:
determining a format associated with the first time; and
determining the second data based on the format.

6. The method of claim 1, wherein the restoring further comprises:
reading a first latched representation of the accumulated time; and
determining the second time based on the first latched representation and the snapshot.

7. The method of claim 6, wherein:
the snapshot of the first time is one of a plurality of snapshots associated with the RTC device; and
the restoring further comprises:
responsive to the reading of the first latched representation, reading first snapshot data from the non-volatile storage representing a first part of the plurality of snapshots;
reading second snapshot data from the non-volatile storage representing a second part of the plurality of snapshots;
reading a second latched representation of the accumulated time;
based on a comparison of the first latched representation and the second latched representation, determining whether the output of the timer changed between the reading of the first snapshot data and the reading of the second snapshot data; and
determining whether to repeat the reading of the first snapshot data and the reading of the second snapshot data based on a result of the comparison.

8. A computer platform comprising:
a plurality of resources to provide a plurality of hosts, wherein each host of the plurality of hosts is associated with a logical computer platform instance; and
a management controller comprising a semiconductor package, wherein the semiconductor comprises:
a hardware processor to provide management services for the plurality of hosts; and
a plurality of hardware real time clock (RTC) devices to provide a plurality of RTC instances.

9. The computer platform of claim 8, wherein a given RTC instance of the plurality of RTC instances measures time for the management controller.

10. The computer platform of claim 8, wherein a given RTC instances of the plurality of RTC instances corresponds to a given host.

11. The computer platform of claim 8, further comprising:
a back-up system to maintain snapshots of states of the RTC devices and restore responsive to a primary power, maintain the snapshots responsive to an outage of the primary power, and update the states of the RTC devices responsive to primary power being restored.

12. The computer platform of claim 11, wherein the power outage corrupts the states of the RTC devices, the back-up system further comprises a timer to measure a time interval corresponding to the power outage, and the back-up system restores the states based on the time interval and the snapshots.

13. The computer system of claim 8, wherein the RTC devices operate independently from each other in respective time domains.

14. A computer platform comprising:
a real time clock (RTC) device to provide a first time responsive to a primary power source being enabled;
a non-volatile storage;
an update controller to, responsive to the primary power source being enabled, store data in the non-volatile storage representing a snapshot of the first time and repeatedly update the snapshot to cause the snapshot to track the first time;
a timer to, responsive to the primary power source being disabled, provide an output representing an accumulated time corresponding to a primary power outage; and
a restore controller to, responsive to the primary power source being reenabled:
sample the output of the timer to provide a sampled accumulated time;
based on the sampled accumulated time and the snapshot, determine a second time; and
cause the RTC device to be updated based on the second time.

15. The computer platform of claim 14, further comprising:
a stored energy source to provide secondary power associated with a secondary power domain,
wherein:
the primary power source to provide primary power associated with a primary power domain; and
the update controller, the restore controller and the RTC device are part of the secondary power domain.

16. The computer platform of claim 14, further comprising:
shadow registers, wherein the shadow registers are part of the secondary power domain,
wherein the restore controller, responsive to the primary power source being enabled:
write shadow data representing a restored state of the RTC device to the shadow registers, wherein the shadow data includes data representing the second time; and
responsive to completion of the writing of the shadow data, cause content of the shadow registers to be transferred to the RTC device.

17. The computer platform of claim 14, wherein the restore controller to further reset the timer responsive to the RTC device being updated.

18. The computer platform of claim 14, wherein the update controller is disabled responsive to the primary power source being reenabled, and the restore controller to further enable the update controller responsive to the RTC device being updated.

19. The computer platform of claim 14, wherein:
the RTC device to further provide data representing a first calendar day;
the first time corresponds to rotational cycles of the Earth;
the update controller to further, responsive to the primary power source being enabled, store data in the non-volatile storage representing a snapshot of the calendar day; and
the restore controller to, responsive to the primary power source being reenabled:
based on the sampled accumulated time and the snapshot, determine a second calendar day; and
cause the RTC device to be updated based on the second calendar day.

20. The computer platform of claim 19, wherein
the RTC device comprising a volatile memory to store configuration data for the computer platform;
the update controller to, responsive to the primary power source being enabled, store data in the non-volatile storage representing a snapshot of the configuration data;
the restore controller to further, responsive to the primary power source being reenabled, read data representing the snapshot of the configuration data and cause the data representing the snapshot of the configuration data to be stored in the volatile memory of the RTC device.
